(19) United States
(12) Patent Application Publication
(10) Pub. No.: US 2019/0319435 A1
(43) Pub. Date: Oct. 17, 2019

(54) Stripzall Oscillating blade

(71) Applicant: Hunter Franssen, Coeur D'Alene, ID (US)

(72) Inventor: Hunter Franssen, Coeur D'Alene, ID (US)

(21) Appl. No.: 15/727,591

(22) Filed: Oct. 7, 2017

(51) Int. Cl. H02G 1/12; B21F 11/00

(52) U.S. Cl. CPC H02G 1/1207; B21F 11/00

(57) ABSTRACT

A blade for cutting and stripping insulation from insulated wires/electrical conductors, as an accessory for a power tool, includes a mounting portion configured to mate with an oscillating drive member of a power tool. A support arm portion extends from the mounting portion in a first direction. The support arm portion includes an inner edge that faces in a second direction transverse to the first direction. A blade portion extends from the support arm generally in the second direction. The blade portion includes a trailing edge arranged facing generally toward the mounting portion and a leading edge arranged facing generally away from the mounting portion. The trailing edge and the leading edge portion meet to define a rounded tip portion.

### BACKGROUND OF THE INVENTION

### 1. Field of the Invention

This invention pertains to cutting tool, and more particularly to a blade for cutting and stripping insulation from insulated electrical conductors.

### 2. Description of the Prior Art

Many terminations of both electrical and optical cables require that the cable be stripped with a section of cable jacket removed from the inner cable core. In all cases, the object of the stripping operation is to remove a section of jacket precisely and cleanly without damaging the inner core in any way. This objective is frequently not met because in order to remove the section of cable jacket during stripping, the cable must be tightly gripped to deform and mark the cable jacket adjacent to the stripped section. Additionally, the pulling of the jacket to remove the stripped section may place tensional loads on both the jacket and the cable core to result in damage to these cable components. Another problem lies with the blades used to strip cable which may nick the cable core, resulting in poor transmission of optical energy in the case of glass or plastic fiber optic cables or in weakened strands in the case of copper electrical conductors.

Industry utilizes two basic types of cutting blades for high production stripping of insulation from insulated electrical conductors, the die type and the V type. In the die type design, a pair of knife blades forms two halves of a counter bored hole and a smaller through hole. The two blades are closed over the insulation of a specifically sized insulated conductor at the desired location thereon. The die type design possesses the advantages of closely conforming to the configuration of the conductor around the full periphery thereof and of having a depth of cut controlled by the contacting of leading edges to prevent nicking and scoring the conductor. Nicking a conductor is undesirable because nicks decrease the electrical current carrying capacity, and they produce stress concentrations which decrease the tensile strength of the conductor. However, die type blades suffer from three disadvantages. The first is that a pair of die blades is designed to be used with only one size of insulated conductor. Secondly, the squeezing of the insulation between the conductor and the blades may prevent the blades from fully closing onto the conductor. The insulation is then not completely cut through to the conductor. Rather, some of the insulation is squeezed in the area between the leading edges and the conductor. As a result, the uncut insulation must be torn from the parent insulation. The third disadvantage is that die type blades have only a low tolerance for accommodating off-center insulated conductors transported between the open blades. In many applications, special wire guides in the form of mechanical fingers are required to ensure the insulated conductor is on the center line of the closed blades.

For a pair of conventional V type blades, each blade is manufactured with a sharp edged cutting radius at the bottom of the V for slicing through the insulation. The cutting radius is ideally equal to one-half of the outer diameter of the conductor to be stripped, but a single pair of V type blades can cut and strip several sizes of insulated conductor. Another advantage of the V type blade design is that the sharp knife edges slice through the insulation to the conductor rather than squeezing the insulation. On the other hand, conventional V type designs lack positive stroke control; therefore the conductor is prone to be nicked and scored when stripped.

The present invention solves all the problems by providing a mountable blade that can be used on any oscillating power tool. Oscillating power tools are lightweight, handheld tools configured to oscillate various accessory tools and attachments, such as cutting blades, sanding discs, grinding tools, and many others.

Accordingly, it is an object of the present invention to provide an improved stripping blade which minimizes damage to a cable, its jacket and core during stripping operations. It is a further object to provide a stripping blade for cable that facilitates a precise, clean, and non-damaging removal of a section of cable jacket from a cable core. It is a final object to provide a stripping blade capable of stripping wires and cables of different sizes.

### SUMMARY OF THE INVENTION

In accordance with the present invention, a mountable blade for an oscillating tool for cutting and stripping insulation from insulated electrical conductors is provided which is capable of stripping or cutting a section of the outer jacketing, coating, or insulation of the electrical wire, copper or aluminum. Owing to the shape of the blade there is no limit to the size or gauge of wire it can strip which can range from 14 AWG to 1000 AWG (American Wire Gauge). This is accomplished by the use of an oscillating tool which can be corded or cordless.

In accordance with one embodiment of the present disclosure, a blade for cutting and stripping insulation from insulated wires/electrical conductors, as an accessory for a power tool, includes a mounting portion configured to mate with an oscillating drive member of a power tool. A support arm portion extends from the mounting portion in a first direction. The support arm portion includes an inner edge that faces in a second direction transverse to the first direction. A blade portion extends from the support arm generally in the second direction. The blade portion includes a trailing edge arranged facing generally toward the mounting portion and a leading edge arranged facing generally away from the mounting portion. The trailing edge and the leading edge portion meet to define a rounded tip portion.

Other objects and advantages of the invention including without limitation construction, demolition, carpet cutting, and wood working will become apparent to those skilled in the art from the disclosure.

### BRIEF DESCRIPTION OF THE DRAWINGS

FIG. 1 is a top elevational view of the oscillating blade;

FIG. 2 is a perspective view of the top of an oscillating tool including an oscillating blade according to one embodiment of the present disclosure;

FIG. 3 is a top view of oscillating blade;

FIG. 4 is a perspective view of the oscillating blade according to one embodiment the present disclosure;

### DETAILED DESCRIPTION OF THE INVENTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one of ordinary skill in the art to which this invention pertains.

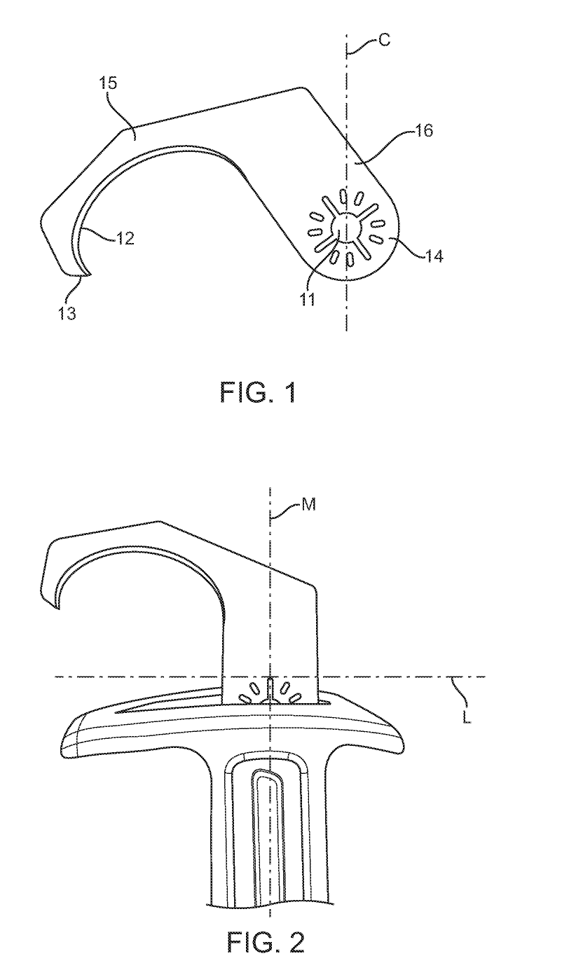

Referring to FIG. 1, a blade for stripping and cutting generally cylindrical bodies is illustrated which includes the present invention. The cutting blade is particularly useful for cutting and stripping insulation from insulated electrical conductors, but it will be understood that the invention is not limited to electrical applications.

Referring to FIGS. 1 and 2, the present disclosure is directed to mounted blade for an oscillating power tool. Mounted blade 15 facilitates using the oscillating power tool in cutting and stripping electrical wires and conductors. Mounted blade 15 includes a mounting portion 14, a support arm portion, and a blade portion 12. The mounting portion 14 secures the blade 15 to the oscillating tool. The blade that is almost U shaped at its upper end will be stamped out of tool steel and sharpened. The top of the blade which is the cutting blade portion 12 has almost a semicircular shape at the cutting end like a large teeth of a Rip blade and the other upper end has the two top sides of an irregular hexagon. The lower end which is the arm portion 16 has a rectangular body closed by a semicircle at the bottom. At this lower end on the mounting portion lies the universal “Starlock” connection 11 which is on the mounting portion 14 which will enable it to be run by many different manufacturers of oscillating tools.

Referring now to FIG. 2, the oscillating tool defines a longitudinal axis L. An oscillating drive member (not shown) extends generally perpendicularly with respect to the longitudinal axis L. The motor is configured to oscillate (left and right movements) the drive member about an axis M at high frequencies, e.g., 5,000 to 25,000 oscillations per minute, with a small oscillating angle, typically, allowing the blade to cleanly and evenly cut through the insulation on the exterior of the wire. It cuts through a small section of the insulation so that the rest of the insulation can easily be pulled off revealing the inner copper or aluminum core.

The drive member supports an accessory tool holder exterior to the housing. The tool holder is configured to secure various accessory tools to the drive member, such as mounted blade 15. As the tool holder is oscillated by the drive member, the accessory tool is driven to oscillate about the axis M of the drive member.

Mounted blade 15 comprises a planar body formed of a hard metal material, such as carbon steel. Mounted blade 15 may be formed by stamping sheet metal with one or more dies that define the perimeter shape and openings of the tool. As depicted, the body is shaped to form a mounting portion 14, a support arm portion 16, and a cutting blade portion 12.

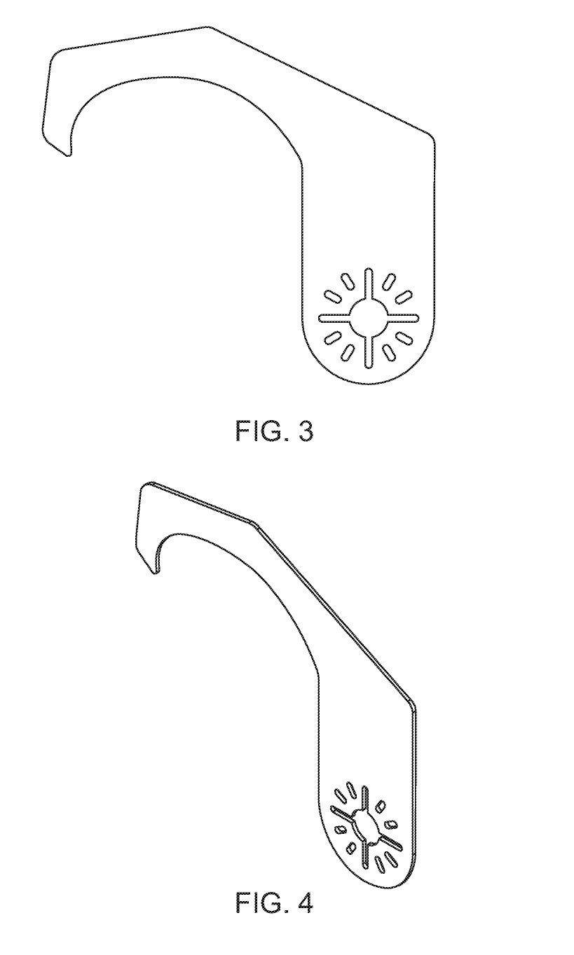

The mounting portion 14 has a generally flat disc-like shape that defines the central opening and smaller openings of the drive structure. As depicted in FIGS. 1, 3 and 4, the mounting portion 14 defines a slot that extends from the central opening through the outer periphery of the mounting portion. The slot enables the mounting portion to be installed and removed from the tool holder. The mounting portion 14 defines a central axis C that is centered in the slot and central opening. The central axis C of the mounting portion defines the default mounting orientation of the blade and serves as a guide for mounting the blade to the tool holder of the oscillating tool. In the default mounting orientation, the mounting portion is secured to the tool holder with the central axis C aligned with the longitudinal axis L of the oscillating tool. The mounting portion, however, can be secured to the tool holder with the central axis C oriented in a plurality of different directions that are transverse to the longitudinal axis L. The mounting portion 14 is secured to the tool holder with the body of the blade arranged parallel to the axis M (FIG. 2) of the drive member. The planar body thus oscillates substantially in a first plane, or oscillation plane, that is parallel to the axis M of the drive member.

The support arm 16 offsets the blade from the mounting portion so the blade, and particularly the semi circular cutting edge 12, can be arranged substantially perpendicular to the directions of oscillating movement of the drive member. The semi circular edge serves as a guide surface and facilitate the cutting or stripping of the wires.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected

Thus, it is apparent that there has been provided, in accordance with the invention, a mountable blade for stripping insulated electrical conductors which fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

I claim:

1. A blade for cutting and stripping insulation from insulated electrical conductors comprising a
a mounting portion configured to mate with an oscillating drive member of a power tool
wherein a support arm portion 16 extends from the mounting portion in a first direction and includes an inner edge that faces in a second direction transverse to the first direction
a blade portion extends from the support arm generally in the second direction
wherein the blade portion includes a trailing edge arranged facing generally toward the mounting portion and a leading edge arranged facing generally away from the mounting portion. The trailing edge and the leading edge portion meet to define a rounded tip portion.

2. The mountable blade of claim 1, wherein the trailing edge includes a circular cutting edge.
